(19) United States
(12) Patent Application Publication
(10) Pub. No.: US 2015/0194129 A1
(43) Pub. Date: Jul. 9, 2015

(54) TOUCH DEVICE AND DATA TRANSMISSION METHOD

(71) Applicant: MediaTek Singapore Pte. Ltd., Singapore (SG)

(72) Inventors: Xiaomeng YAN, Tianjin (CN); Tzu-Wen CHANG, Taipei City (TW); Yanni HUANG, Beijing (CN); LIN XU, Tianjin (CN)

(21) Appl. No.: 14/587,255

(22) Filed: Dec. 31, 2014

(30) Foreign Application Priority Data
Jan. 3, 2014 (CN) 201410003596.0

(51) Int. Cl. G09G 5/12; G06F 3/14; G06F 3/0484; G06F 3/0488; G06F 3/041; G06F 3/0481

(52) U.S. Cl. CPC G09G 5/12; G06F 3/0412; G06F 3/0416; G06F 3/04817; G06F 3/0484; G06F 3/0488; G06F 3/1454; G06F 3/1423; G09G 2354/00; G09G 2370/16; G09G 2370/22

(57) ABSTRACT

A touch device includes an execution module, a sensing electrode and a first control module. The execution module is configured to implement a user interface. The sensing electrode is configured to sense a touch event of an icon corresponding to the user interface. The first control module is configured to couple to the sensing electrode, enable a distribution setting according to the touch event, build a first communication channel according to a physical adjacency between the touch device and another touch device, and send transmitting data corresponding to the distribution setting to the other touch device through the first communication channel.

### CROSS REFERENCE TO RELATED APPLICATIONS

This application claims priority of China Patent Application No. 201410003596.0, filed on Jan. 3, 2014, the entirety of which is incorporated by reference herein.

### BACKGROUND OF THE INVENTION

1. Field of the Invention

The application relates in general to a touch device and data transmission method, and in particular to a touch device and data transmission method for transmitting data to another touch device through a first communication channel by a touch event, wherein the first communication channel is built by a physical adjacency between the touch device and the other touch device.

2. Description of the Related Art

Due to the developing of the information market, users often send or receive data via a wired or wireless transmission technology in everyday life. However, for wired-transmission technology, the pairing process must directly couple electronic devices for building an interconnect mechanism as a starting point. For wireless transmission technology, the device must be set before the pairing operation through a complex communication protocols authority, but also must be set by the user to turn on manually or automatically. The wired or wireless transmission technology as described above might cause limitations or a poor user experience due to the complexity of the steps. Thus, how to provide an easy way for the user to send or receive data is worthy of discussion.

### BRIEF SUMMARY OF INVENTION

The invention provides a touch device and data transmission method for solving the aforementioned problems.

An embodiment of the invention provides a touch device, comprising an execution module, a sensing electrode and a first control module. The execution module is configured to implement a user interface. The sensing electrode is configured to sense a touch event of an icon corresponding to the user interface. The first control module is configured to couple to the sensing electrode, enable a distribution setting according to the touch event, build a first communication channel according to a physical adjacency between the touch device and another touch device, and send transmitting data corresponding to the distribution setting to another touch device through the first communication channel.

Another embodiment of the invention provides a data transmission method, adapted to a touch device, the steps comprise: implementing a user interface; sensing a touch event of an icon corresponding to the user interface; enabling a distribution setting according to the touch event; building a first communication channel according to a physical adjacency between the touch device and another touch device; and sending transmitting data corresponding to the distribution setting to another touch device through the first communication channel.

A touch device and data transmission method provided by the invention can improve the user's experience thanks to the simplicity of operation.

### BRIEF DESCRIPTION OF DRAWINGS

The invention can be more fully understood by reading the subsequent detailed description and examples with references made to the accompanying drawings, wherein:

FIG. 1 is a schematic drawing of the touch device in accordance with an embodiment of the invention;

FIG. 2 is a schematic drawing of the physical adjacency between two touch devices in accordance with an embodiment of the invention;

FIG. 3 is a schematic drawing of building a connection between two touch devices in accordance with an embodiment of the invention;

FIG. 4 is a schematic drawing of building a connection between two touch devices in accordance with another embodiment of the invention;

FIG. 5 is a schematic drawing of building a connection between two touch devices in accordance with another embodiment of the invention;

FIG. 6 is a schematic drawing of a display device which has the touch device in accordance with an embodiment of the invention;

FIG. 7 is a flow chart of a data transmission method in accordance with an embodiment of the invention; and

FIG. 8 is a flow chart of a data transmission method in accordance with another embodiment of the invention.

### DETAILED DESCRIPTION OF INVENTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The following description is a preferred embodiment of the present invention for describing the principle of the invention, but is not intended to limit the scope of the invention. It should be noted that the embodiment of the present invention can be implemented by software, hardware, firmware or any combination thereof.

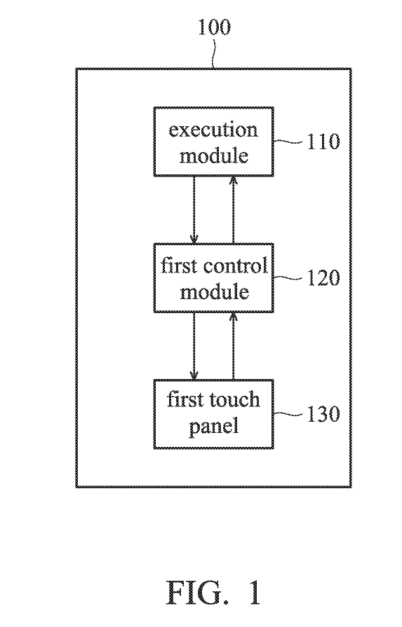

FIG. 1 is a schematic drawing of the touch device in accordance with an embodiment of the invention. As shown in FIG. 1, the touch device 100 includes an execution module 100, a first control module 120 and a first touch panel 130. The touch device 100 can be a PDA, mobile phone, smartphone, notebook computer, tablet computer, game device, EBook, calculator, television, ticket booth, digital photo frame, point-of-sale terminal, digital map or any other electronic device, but it is not limited thereto. It should be noted that one of the touch devices used to implement the transmission can be a mobile device or a fixed device, or both of the touch devices can be mobile devices or fixed devices. The execution module 100 is arranged to implement a user interface. The user interface can be a multimedia application, document management program, phonebook, E-mail, etc., which has an icon for sharing any document stored in the user interface. The document can be any type of data file, for example a picture, audio, or video application included the document, Vcard, file group, etc. It should be noted that the icon can be a picture, character or a combination of the two. The first touch panel 130 includes a plurality of detection electrodes, configured to sense a touch event. For example, the first touch panel 130 can be a capacitive touch panel. The first control module 120 couples to the execution module 110 and the detection electrodes, and is configured to apply the electronic signal to the detection electrodes for generating an electric field according to the touch event corresponding to the position of the icon. The electronic signal can be a high-frequency carrier signal coupled between the detection electrodes.

According to an embodiment of the present invention, when the execution module 110 implements the user interface, such as the multimedia database, the user can share the files stored in the multimedia database by touching the icon. For example, the capacitance of the first touch panel 130 corresponding to the position of the icon will be changed when the user touches the icon, and the first control module 120 will set the files selected by the user or the files stored in the multimedia database (in cases where the user does not select any file) as a transmission packet and apply the electronic signal to the detection electrodes for generating the electric field. The execution module 110 further determines whether the user enables the function of the first control module 120 for applying the electronic signal, and if the user does not enable the function, the display module of the touch device 100 will display a reminder window for reminding the user to enable the function as described above.

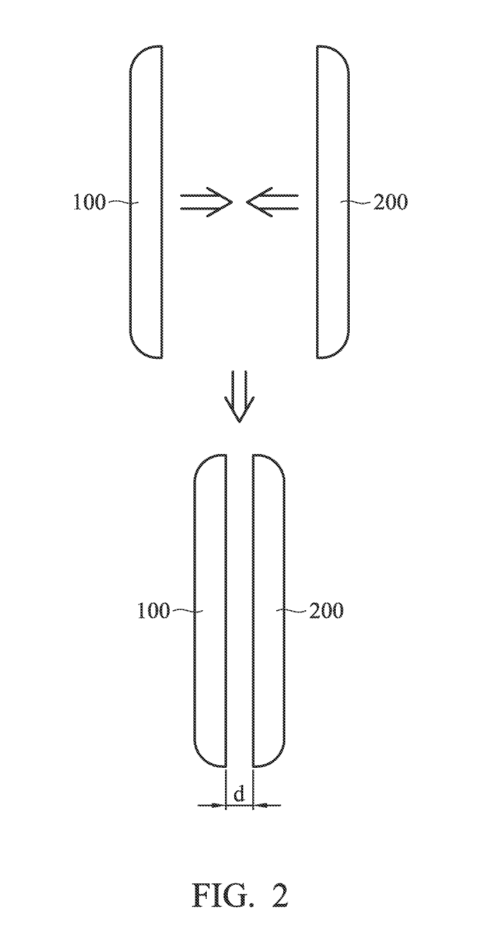

Please refer to FIG. 2. FIG. 2 is a schematic drawing of the physical adjacency between two touch devices in accordance with an embodiment of the invention. When enabling the function of the first control module 120 for applying the electronic signal, the user can build the first communication channel by closing or fitting the two touch devices (which means that the physical adjacency between the two touch devices is less than a predetermined range, the predetermined range can be a distance d shown in the bottom portion of FIG. 2, and the distance d is equal to 5 mm) for generating an interaction of the field between the two touch devices. It should be noted that the distance d shown in FIG. 2 is just one example, and it can be greater or less than 5 mm, but it is not intended to limit the present invention. Furthermore, the other touch device 200 includes a second control module and a sensing module (not shown). The second control module is arranged to couple to a second touch panel, and enable the second control module for building the first communication channel according to the physical adjacency sensed by the sensing module.

According to an embodiment of the present invention, the sensing module included in the other touch device 200 can enable the function of the second control module for applying the electronic signal. The sensing module can be a proximity sensor. For example, the other touch device 200 enables the function of the second control module for applying the electronic signal when the sensing module senses that an object is physically adjacent to the other touch device 200.

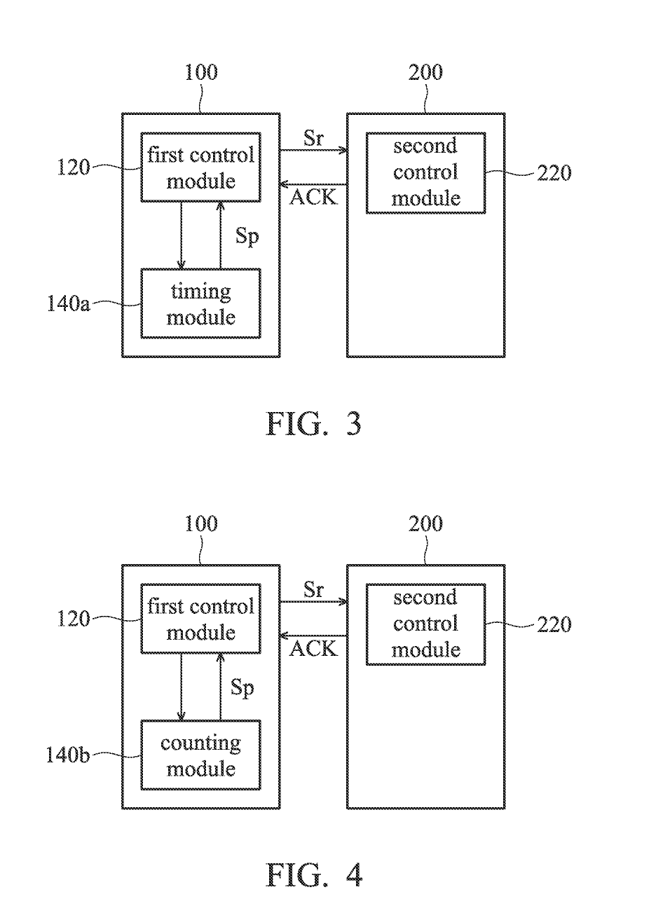

FIG. 3 is a schematic drawing of building a connection between two touch devices in accordance with an embodiment of the invention. As shown in FIG. 3, the touch device 100 may include a timing module 140a. When the first control module 120 sends a request signal Sr to the other touch device 200 through the first communication channel, if the second control module 220 returns an Acknowledgment message (ACK), it means that the connection between the two touch devices has successfully been built and the transmitting data corresponding to the distribution setting has started to transmit. However, if the first control module 120 does not receive the Acknowledgment message sent by the second control module 220 within a predetermined time (e.g. 10 seconds), it means that the connection between the two touch devices has failed, and the timing module 140a will send a stop signal Sp for notifying the first control module 120 to stop sending the transmitting data corresponding to the distribution setting. In an embodiment of the present invention, the display module of the touch device 100 further displays a transmission-is-failed window or makes an alert tone for notifying the user that the connection has failed. It should be noted that, in the predetermined time, the first control module 120 can send request signal Sr once or send the request signal repeatedly to the other touch device 200 through the first communication channel. If the first control module 120 sends the request signal repeatedly, the timing module 140a starts counting the time from the first request. The failure of the connection may be one of the touch devices or both of the touch devices not enabling the function of applying the electronic signal, or the physical adjacency between the two touch devices is greater than the predetermined range.

FIG. 4 is a schematic drawing of building a connection between two touch devices in accordance with another embodiment of the invention. As shown in FIG. 4, the touch device 100 may include a counting module 140b. When the first control module 120 sends the request signal Sr to the other touch device 200 through the first communication channel more than a predetermined number of times (e.g. 10 times), the counting module 140b will send a stop signal Sp for notifying the first control module 120 to stop sending the transmitting data of the distribution setting when the first control module 120 fails to receive an Acknowledgment message which means that the connection between the two devices has failed. In an embodiment of the present invention, the display module of the touch device 100 further displays the transmission-is-failed window or makes the alert tone and/or the vibration for notifying the user that the connection has failed.

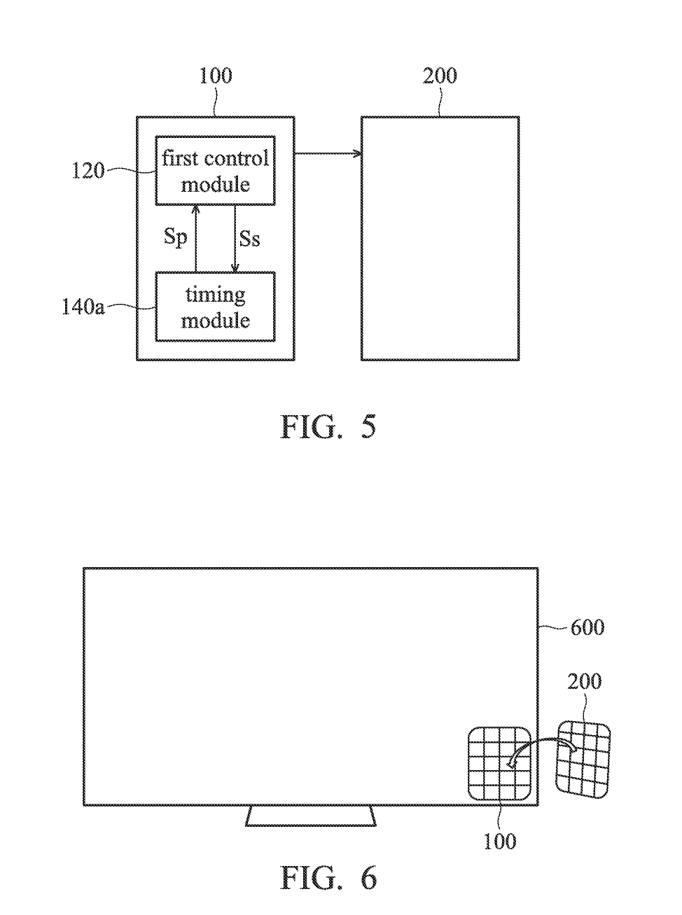

FIG. 5 is a schematic drawing of building a connection between two touch devices in accordance with another embodiment of the invention. As shown in FIG. 5, when the other touch device 200 does not include the Acknowledgment function which is used to respond to the request signal Sr, the first control module 120 can determine whether the connection has been built successfully by using the timing module 140a. After the first control module 120 sends the transmitting data corresponding to the distribution setting, if the timing module 140a does not receive a successfully transmitted signal Ss sent by the first control module 120 within a predetermined time (e.g. 15 seconds), the first control module 120 determines that the connection between the two touch devices has failed. Then, the timing module 140a will send the stop signal Sp for notifying the first control module 120 to stop sending the transmitting data corresponding to the distribution setting. In an embodiment of the present invention, the display module of the touch device 100 further displays the transmission-is-failed window or makes the alert tone and/or the vibration for notifying the user that the connection has failed.

According to another embodiment of the present invention, the first control module 120 further determines data quantity corresponding to the transmitting data. When the data quantity of the transmitting data is less than or equal to a predetermined value (e.g. 4k bytes), the transmitting data corresponding to the distribution setting is sent through the first communication channel built by the physical adjacency between the two touch devices. When the data quantity of the transmitting data is greater than the predetermined value, the transmitting data corresponding to the distribution setting is sent through the second communication channel built by the first control module 120 since it may take more time if the transmitting data is sent through the first communication channel and the user may have poor experience. A data transmission rate of the second communication channel is greater than a data transmission rate of the first communication channel, and the second communication channel can be built by Bluetooth Protocol or Wi-Fi Protocol. When the data quantity of the transmitting data is greater than the predetermined value, the Bluetooth Protocol or the Wi-Fi Protocol can be enabled by sending a permission-controlled setting. It should be noted that this is just an example of building a second communication channel with the Bluetooth Protocol or the Wi-Fi Protocol, and the second communication channel can be built using another Protocol (e.g. NFC, RFID etc.), but it is not limited thereto.

It should be noted that the predetermined value can be a value greater than or less than 4k bytes, but it is not limited thereto.

According to an embodiment of the present invention, the other touch device 200 may further include a display module. The display module displays a reception-is-completed window when the other touch device 200 finishes receiving the transmitting data corresponding to the distribution setting. The other touch device 200 may further include a sound module or a vibration module. The sound module or the vibration module makes an alert tone or a vibration for notifying the user that the data transmission has finished.

According to another embodiment of the present invention, the other touch device 200 may further include a determining-received module. The other touch device 200 will receive the packet information corresponding to the transmitting data before the other touch device 200 starts receiving the transmitting data corresponding to the distribution setting, wherein the packet information includes the actual data quantity of the transmitting data. When the other touch device 200 finishes receiving the transmitting data corresponding to the distribution setting, the determining-received module determines whether the received data quantity of the transmitting data is equal to the data quantity of the transmitting data of the distribution setting or not, and the display module displays the reception-is-failed window or makes the alert tone and/or the vibration for notifying the user that the transmission has failed when the received data quantity of the transmitting data is less than the data quantity of the transmitting data of the distribution setting.

According to an embodiment of the present invention, the transmitting data is stored to the document of the implemented user interface corresponding to the touch device 100 by the other touch device 200 when the other touch device 200 finishes receiving the transmitting data corresponding to the distribution setting. It will reduce the time for searching the received data by the user.

Please refer to FIG. 6. FIG. 6 is a schematic drawing of a display device which has the touch device in accordance with an embodiment of the invention. Since the cost of a large display device wherein the entire display panel has a touch function is too high, according to an embodiment of the present invention as shown in FIG. 6, some regions of the display device 600 which are called a sub region has a touch function. The sub region includes the touch device 100. The touch device 100 and the other touch device 200 can transmit data to each other, and the touch device 100 includes all functions recited in the embodiments of FIG. 1 to FIG. 5.

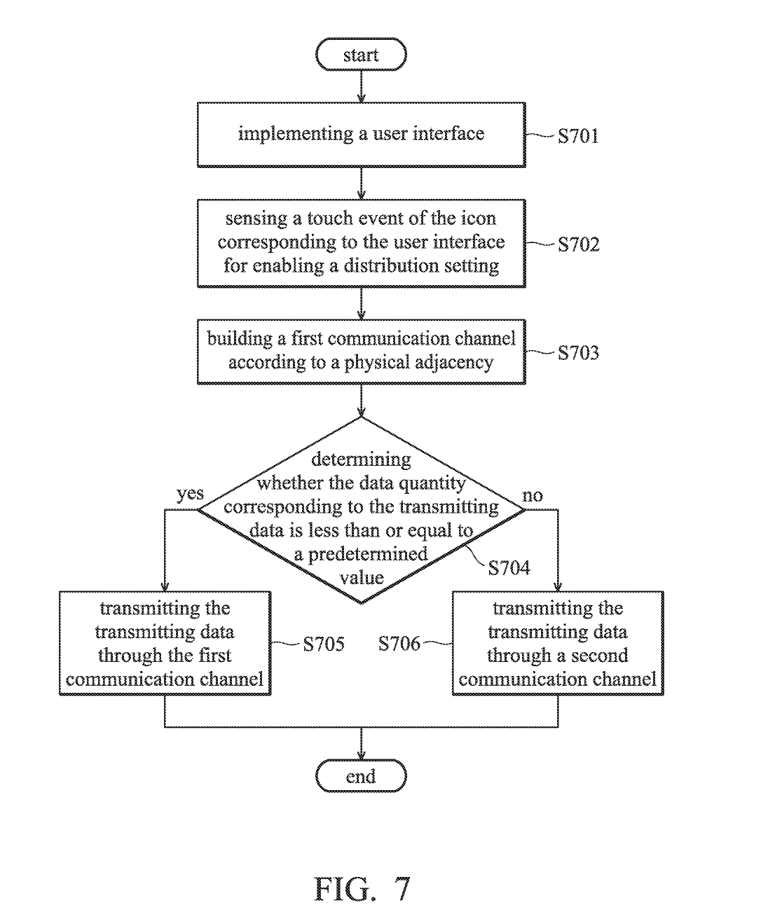

Please refer to FIG. 7 with FIG. 1. FIG. 7 is a flow chart of a data transmission method in accordance with an embodiment of the invention. In step S701, the user implements a user interface. The user interface can be the multimedia application, document management program, phonebook or E-mail etc., which has an icon for sharing any document stored in the user interface. It should be noted that the icon can be a picture, character or a combination of the two. Then the method proceeds to step S702, in which the first touch panel 130 senses a touch event of the icon corresponding to the user interface for enabling a distribution setting, which means that the user can share any file stored in the user interface by touching the icon. For example, the capacitance of the first touch panel corresponding to the position of the icon will be changed when the user touches the icon, and the first control module 120 will set the files selected by the user or the files stored in the multimedia database (in cases where the user does not select any file) as a transmission packet and apply the electronic signal to the detection electrodes for generating the electric field. It should be noted that the touch event can occur at the time that the file is implemented, or at the time that the file is disabled, but it is not limited thereto.

Please refer to FIG. 7 with FIG. 2. At step S703, the touch device 100 builds a first communication channel according to a physical adjacency. The physical adjacency means that the distance between the touch device and another touch device is less than a predetermined range (for example, the predetermined range can be 5 mm). In other words, the user can build the first communication channel by closing or fitting the two touch devices for interacting the electric field between the two touch devices. It should be noted that, in an embodiment of the present invention, the process for building the first communication channel according to the physical adjacency recited in step S703 is implemented in situations where the touch device 100 is enabled to apply the electronic signal. In another embodiment of the present invention, step S703 is implemented in situations where both the touch device 100 and the other touch device 200 are enabled to apply the electronic signal. Thus, before building the first communication channel, the steps further determine whether the function for applying the electronic signal of the touch device 100 or both the touch device 100 and the other touch device 200 are enabled or not. If the function is disabled, it can be enabled automatically or manually, but it is not limited thereto.

The method proceeds to step S704, the first control module 120 determines the data quantity corresponding to the transmitting data. When the data quantity corresponding to the transmitting data is less than or equal to a predetermined value, the method proceeds to step S705, the transmitting data is sent through the first communication channel. When the data quantity corresponding to the transmitting data is greater than the predetermined value, the method proceeds to step S706, the control module 120 transmits the transmitting data through a second communication channel. A data transmission rate of the second communication channel is greater than the data transmission rate of the first communication channel, and it is built by the Bluetooth Protocol or Wi-Fi Protocol and so on.

According to an embodiment of the present invention, the display module of the other touch device 200 displays a reception-is-completed window when the other touch device 200 finishes receiving the transmitting data of the distribution setting (when finishing step S705 or step S706). Or the other touch device 200 may further includes a sound module or a vibration module, the sound module or the vibration module makes an alert tone or a vibration for notification when the other touch device 200 finishes receiving the transmitting data of the distribution setting. According to another embodiment of the present invention, the touch device 200 may further include a determining-received module. The determining-received module determines whether the received data quantity of the transmitting data is equal to the data quantity of the transmitting data of the distribution setting or not, and the display module displays a reception-is-failed window or makes an alert tone or vibration for notifying the user that the transmission has failed when the received data quantity of the transmitting data is less than the data quantity of the transmitting data of the distribution setting.

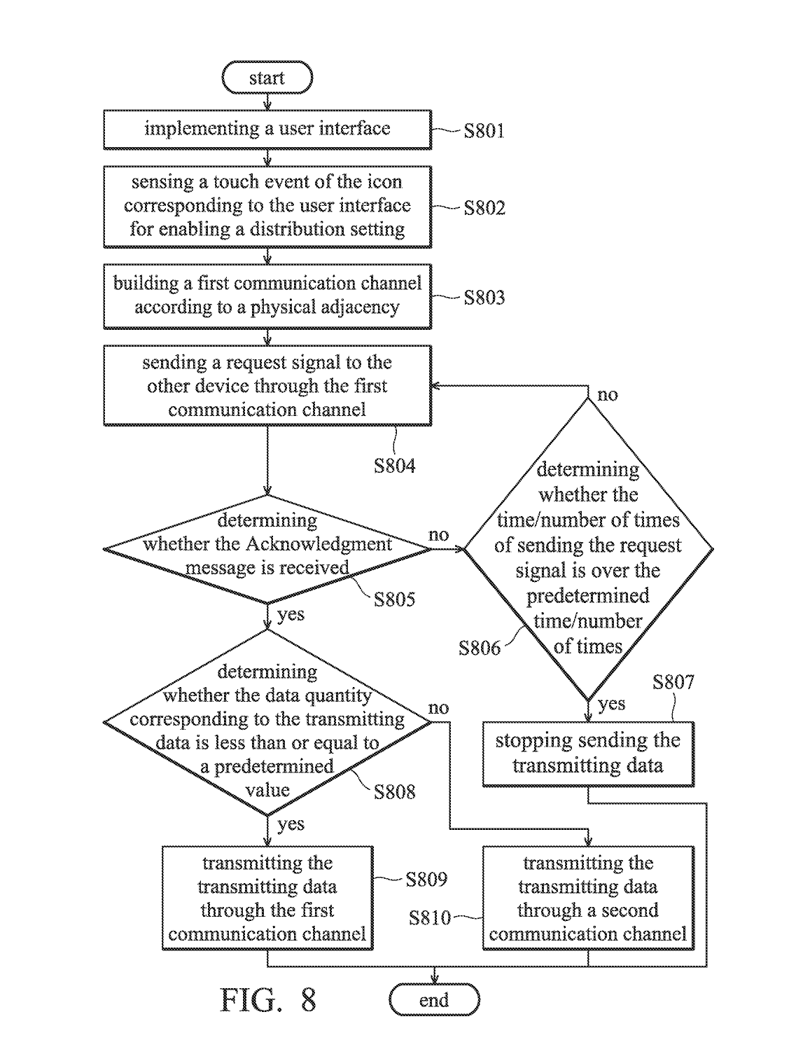

Please refer to FIG. 8 with FIG. 1. FIG. 8 is a flow chart of a data transmission method in accordance with another embodiment of the invention. The operation process for step S801 to step S803 is the same as step S701 to step S703 recited in FIG. 7, thus it is not described herein. At step S804, the first control module 120 sends a request signal Sr to the other touch device 200 through the first communication channel. At step S805, the touch device 100 determines whether the Acknowledgment message is received or not. If the second control module returns an Acknowledgment message (ACK), it means that the connection between the two touch devices has successfully been built. Then the method proceeds to step S808, the operation process for step S808 to step S810 is the same as step S704 to step S706 recited in FIG. 7, thus it is not described herein.

However, if the first control module 120 does not receive the Acknowledgment message within a predetermined time (e.g. 10 seconds), the first control module 120 will repeatedly send the request signal to the touch device 200 until the predetermined time is reached. At step S806, the touch device 100 determines whether the time of sending the request signal is over the predetermined time or not. If the first control module 120 does not receive the Acknowledgment message over the predetermined time (e.g. 10 seconds), it means that the connection between the two touch devices has failed, and the timing module 140a will send a stop signal Sp for notifying the first control module 120 to stop sending the transmitting data corresponding to the distribution setting (step S807), and the display module of the touch device 100 further displays a transmission-is-failed window or makes an alert tone for notifying the user that the connection has failed. The reason for failing to creat the connection between the touch devices may be that one of the touch devices or both of the touch devices do not enable the function for applying the electronic signal, or the physical adjacency between the two touch devices is greater than the predetermined range.

According to another embodiment of the present invention, the touch device 100 may include a counting module 140b. When the first control module 120 does not receive the Acknowledgment message sent by the other touch device 200 and the request signal is sent to the other touch device 200 through the first communication channel in a predetermined number of times (e.g. 10 times), the first control module 120 sends the request signal repeatedly. At step S806, the touch device 100 determines whether the times of sending the request signal is over the predetermined number of times or not. However, when the first control module 120 sends the request signal to the other touch device 200 through the first communication channel more than a predetermined number of times (e.g. 10 times) and fails to receive Acknowledgment message sent by the second control module 220, which means that the connection between the two touch devices has failed, the counting module 140b will send a stop signal Sp for notifying the first control module 120 to stop sending the transmitting data of the distribution setting (step S807), and the display module of the touch device 100 further displays the transmission-is-failed window or makes the alert tone and/or the vibration for notifying the user that the connection has failed.

In addition, when the other touch device 200 does not have the acknowledgment function to respond to the request signal Sr, the first control module 120 can determine whether the connection has been built successfully by using the timing module 140a. After the first control module 120 sends the transmitting data corresponding to the distribution setting (step S705), if the timing module 140a does not receive a successfully transmitted signal Ss sent by the first control module 120 within a predetermined time (e.g. 15 seconds), the first control module 120 determines that the connection between the two touch devices has failed. Then, the timing module 140a will send the stop signal Sp for notifying the first control module to stop sending the transmitting data corresponding to the distribution setting, and the display module of the touch device 100 further displays the transmission-is-failed window or makes the alert tone and/or vibration for notifying the user that the connection has failed.

The touch device 100 and the other touch device 200 are only be the embodiments of the present invention, persons skilled in the art will understand that the number of touch devices can be greater than two, for example the three touch devices 300, 301 and 302. When the touch device 300 makes the physical adjacency to the touch device 301 and 302 at the same time, the touch device 300 can build the connection and transmit the transmitting data to the touch device 301 and 302 at the same time, or build the connection and transmit the transmitting data to the touch device 301 and 302 at different times, but it is not limited thereto.

As described above, according to the proposed touch device in the embodiment of the present invention, the user can easily transmit the shared transmitting data to the other touch device by touching the icon of the user interface and being physical adjacency to the other touch device, and the required permission setting of the Bluetooth Protocol or Wi-Fi Protocol can be avoided using the method for improving user experience.

The embodiments of the data transmission methods of the present invention can be implemented by hardware, software coding, or a combination of the two. For example, the embodiment of the present invention can be integrated into the circuit with the video compression chip or the video compression software for implementing the code. The embodiment of the present invention can be a code which is implemented in the Digital Signal Processor (DSP). The present invention may also be related to a variety of functions implemented in a computer processor, a digital signal processor, a microprocessor or a Field Programmable Gate Array (FPGA). The present invention can be implemented by a processor executing the machine-readable software code or firmware code. The software code or the firmware code can be any type of programming language, or decoded by different target platforms. However, the software code and other software code with different types, or language are within the scope or spirit of the invention.

The words “first”, “second”, and “third” recited in the specification do not mean to have any preference, priority or grade of an element higher than other element or method of execution, but only used to distinguish the different elements with the same function.

It will be apparent to those skilled in the art that various modifications and variations can be made to the structure disclosed without departing from the scope or spirit of the invention. In view of the foregoing, it is intended that the present invention covers modifications and variations of this invention, provided they fall within the scope of the following claims and their equivalents.

What is claimed is:

1. A touch device, comprising:
an execution module, configured to implement a user interface;
a sensing electrode, configured to sense a touch event of an icon corresponding to the user interface;
a first control module, configured to couple to the sensing electrode, enable a distribution setting according to the touch event, build a first communication channel according to a physical adjacency between the touch device and the other touch device.

2. The touch device as claimed in claim 1, wherein the first control module is configured to send transmitting data corresponding to the distribution setting to the other device through the first communication channel.

3. The touch device as claimed in claim 1, wherein the touch device further comprises a first touch panel, and the first touch panel comprises the sensing electrode; the other touch device comprises the second touch panel, and the physical adjacency between the touch device and the other touch device means a distance between the first touch panel and the other touch panel is less than a predetermined range.

4. The touch device as claimed in claim 3, wherein the other touch device further comprises a second control module and a sensing module, and the second control module is configured to couple to the second touch panel and build the first communication channel according to the physical adjacency sensed by the sensing module.

5. The touch device as claimed in claim 1, wherein the first control module determines data quantity corresponding to the transmitting data, sends the transmitting data through the first communication channel when the data quantity corresponding to the transmitting data is less than or equal to a predetermined value, and builds a second communication channel for transmitting the transmitting data when the data quantity corresponding to the transmitting data is greater than the predetermined value.

6. The touch device as claimed in claim 5, wherein a data transmission rate of the second communication channel is greater than a data transmission rate of the first communication channel.

7. The touch device as claimed in claim 6, wherein the second communication channel is built by Bluetooth Protocol or Wi-Fi Protocol.

8. The touch device as claimed in claim 1, wherein the other touch device further comprises a display module, the display module displays a reception-is-completed window when the other touch device finishes receiving the transmitting data of the distribution setting.

9. The touch device as claimed in claim 1, wherein the other touch device further comprises a sound module or a vibration module, the sound module or the vibration module makes an alert tone or a vibration for notification when the other touch device finishes receiving the transmitting data of the distribution setting.

10. The touch device as claimed in claim 1, wherein the other touch device further comprises a determining-received module, the determining-received module determines whether the received data quantity of the transmitting data is equal to the data quantity of the transmitting data of the distribution setting or not, and the display module displays a reception-is-failed window when the received data quantity of the transmitting data is less than the data quantity of the transmitting data of the distribution setting.

11. The touch device as claimed in claim 1, wherein the touch device further comprises a timing module, when the first control module sends a request signal to the other touch device through the first communication channel, the timing module sends a stop signal for notifying the first control module to stop sending the transmitting data of the distribution setting when the first control module fails to receive Acknowledgment message within a predetermined time.

12. The touch device as claimed in claim 1, wherein the touch device further comprises a counting module, when the first control module sends a request signal to the other touch device through the first communication channel more than a predetermined number of times, the counting module sends a stop signal for notifying the first control module to stop sending the transmitting data of the distribution setting when the first control module fails to receive Acknowledgment message.

13. The touch device as claimed in claim 1, wherein the touch device further comprises a timing module, the timing module sends a stop signal to the first control module to stop sending the transmitting data of the distribution setting when the first control module fails to send the transmitting data of the distribution setting to the other touch device within a predetermined time.

14. A display device, comprising a sub region, wherein the sub region comprises the touch device as claimed in claim 1.

15. A data transmission method, adapted to a touch device, comprising:
implementing a user interface;
sensing a touch event of an icon corresponding to the user interface;
enabling a distribution setting according to the touch event; and
building a first communication channel according to a physical adjacency between the touch device and the other touch device.

16. The data transmission method as claimed in claim 15, further comprises sending transmitting data corresponding to the distribution setting to the other touch device through the first communication channel.

17. The data transmission method as claimed in claim 15, wherein the physical adjacency means a distance between the touch device and the other touch device is less than a predetermined range.

18. The data transmission method as claimed in claim 15, wherein the steps further comprise determining data quantity corresponding to the transmitting data, wherein:
when the data quantity corresponding to the transmitting data is less than or equal to a predetermined value, the transmitting data is sent through the first communication channel; and
when the data quantity corresponding to the transmitting data is greater than the predetermined value, builds a second communication channel for transmitting the transmitting data.

19. The data transmission method as claimed in claim 18, wherein a data transmission rate of the second communication channel is greater than a data transmission rate of the first communication channel.

20. The data transmission method as claimed in claim 19, wherein the second communication channel is built by Bluetooth Protocol or Wi-Fi Protocol.

21. The data transmission method as claimed in claim 15, wherein a display module of the other touch device displays a reception-is-completed window when the other touch device finishes receiving the transmitting data of the distribution setting.

22. The data transmission method as claimed in claim 15, wherein the steps further comprise:
making an alert tone or a vibration for notification when the other touch device finishes receiving the transmitting data of the distribution setting.

23. The data transmission method as claimed in claim 15, wherein the steps further comprise:
determining whether the received data quantity of the transmitting data is equal to the data quantity of the transmitting data of the distribution setting or not; and
displaying a reception-is-failed window when the received data quantity of the transmitting data is less than the data quantity of the transmitting data of the distribution setting.

24. The data transmission method as claimed in claim 15, wherein when the first control module sends a request signal to the other touch device through the first communication channel,
sending a stop signal for notifying the first control module to stop sending the transmitting data of the distribution setting when the first control module fails to receive Acknowledgment message within a predetermined time.

25. The data transmission method as claimed in claim 15, wherein when the first control module sends a request signal to the other touch device through the first communication channel more than a predetermined number of times,
sending a stop signal for notifying the first control module to stop sending the transmitting data of the distribution setting when the first control module fails to receive Acknowledgment message.

26. The data transmission method as claimed in claim 15, wherein a timing module of the touch device sends a stop signal to the first control module to stop sending the transmitting data of the distribution setting when the first control module fails to send the transmitting data of the distribution setting to the other touch device within a predetermined time.
